(19) United States
(12) Patent Application Publication
(10) Pub. No.: US 2004/0054444 A1
(43) Pub. Date: Mar. 18, 2004

(54) METHOD OF UPLOADING DATA FROM A VEHICLE

(76) Inventors: Edward J. Abeska, Ferndale, MI (US); Michael J. Peterson, Farmington Hills, MI (US); Daniel A. Hanevich, Camirallo, CA (US)

Correspondence Address: ANTHONY LUKE SIMON, General Motors Corporation, Legal Staff, Mail Code 482-C23-B21, 300 Renaissance Center, P.O. Box 300, Detroit, MI, 48265-3000, US

(21) Appl. No.: 10/244,193

(22) Filed: Sep. 16, 2002

(51) Int. Cl. G06F 19/00

(52) U.S. Cl. 701/1; 701/35

(57) ABSTRACT

The invention provides a method for uploading data from a vehicle. A type of data may be selected for collection, and stored on a vehicle control processor. A trigger event may be selected and stored on the vehicle control processor for determining when the collected data may be uploaded to a central data repository. The data stored in vehicle control processor memory may be uploaded to the central data repository whenever this upload trigger event occurs.

### FIELD OF THE INVENTION

In general, the invention relates to vehicle data collection. In particular, this invention relates to a method for uploading a vehicle's collected data to a central data repository.

### BACKGROUND OF THE INVENTION

Currently it is possible to collect and store information pertaining to a vehicle's location and vehicle information. This data is occasionally uploaded to a central data repository for analysis.

Existing automotive data storage systems require the service provider to know in advance what data needs to be stored before sending the system into the field. The service provider also needs to know in advance when to store the data, as well as what events might trigger the uploading of the stored data to the central data repository. This information is hard coded into the system and requires a module replacement or reprogramming if it is later decided that the system should collect an alternate set of data points. Both module replacement and reprogramming require the unit to be returned to the dealer for the work to be done.

A system that can be reprogrammed in the field without returning to the dealer would be desirable. The data collection device could be programmed at the factory with a general profile including the type of data to be recorded and the events that trigger the uploading of that data to the central data repository, and then altered at any time in the field to better suit the user. This would allow dynamic configuration of the data collection device, and services could be determined and supported after the vehicle has left the dealership. Only data pertaining to the service in use is collected, limiting the amount of stored data and, therefore, reducing the amount of storage memory necessary. As newer services become available the data collection device could be programmed to accommodate them at any time.

Existing automotive data storage systems also require the vehicle to be running in order to communicate with the central data repository and upload data. A system that could communicate with the central data repository while the vehicle is powered off would be desirable. Such a system could communicate with the central data repository while the vehicle is not in use and would present the user with minimum inconvenience.

Thus, there is a significant need for a method for improving vehicle data collection so that the potential benefits of uploading vehicle data can be realized.

### SUMMARY OF THE INVENTION

One aspect of the invention provides a method for uploading data from a vehicle. A type of data may be selected for collection, and stored on a vehicle control processor. A trigger event may be selected and stored on the vehicle control processor for determining when the collected data may be uploaded to a central data repository. The data stored in vehicle control processor memory may be uploaded to the central data repository whenever this upload trigger event occurs.

Another aspect of the invention provides a method for selecting and storing a trigger event in vehicle control processor memory for the collection of vehicle data. Data may be stored in vehicle control processor memory whenever this data storage trigger occurs. A specific amount of vehicle processor memory may be reserved for storage of each selected data type to be collected.

Another aspect of the invention provides a method for downloading information to the vehicle in order to program the vehicle control processor for data collection. This information may include the types of data to be collected, the events that may trigger the collection of the data, and the events that may trigger the uploading of the data to the central data repository.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of a system for generating navigation information for a vehicle in accordance with the present invention;

FIG. 2 is a schematic diagram of another embodiment of a system for generating navigation information for a vehicle in accordance with the present invention;

FIG. 3 is a schematic diagram of one embodiment of a navigation subsystem in accordance with the present invention;

FIG. 4 is a flowchart of one embodiment of a remote configuration of event tables and storing data on a vehicle control processor in accordance with the present invention;

FIG. 5 is a flowchart of one embodiment of a process of storing data on the vehicle control processor in accordance with the present invention;

FIG. 6 is a flowchart of one embodiment of a process of placing a call in FIG. 5 and uploading stored data in FIG. 4 from the vehicle control processor to a call center data repository in accordance with the present invention;

FIG. 7 is a chart demonstrating one embodiment of how an action event table may be configured in accordance with the present invention;

FIG. 8 is a chart demonstrating one embodiment of how an upload event table of may be configured corresponding to the action event table of FIG. 7 in accordance with the present invention;

FIG. 9 is a chart demonstrating another embodiment of how the action event table may be configured in accordance with the present invention;

FIG. 10 is a chart demonstrating another embodiment of how the upload event table may be configured corresponding to the action event table of FIG. 9 in accordance with the present invention;

FIG. 11 is a chart demonstrating another embodiment of how the action event table of may be configured in accordance with the present invention; and

FIG. 12 is a chart demonstrating another embodiment of how the upload event table of may be configured corresponding to the action event table of FIG. 11 in accordance with the present invention.

### DETAILED DESCRIPTION OF A PREFERRED EMBODIMENT

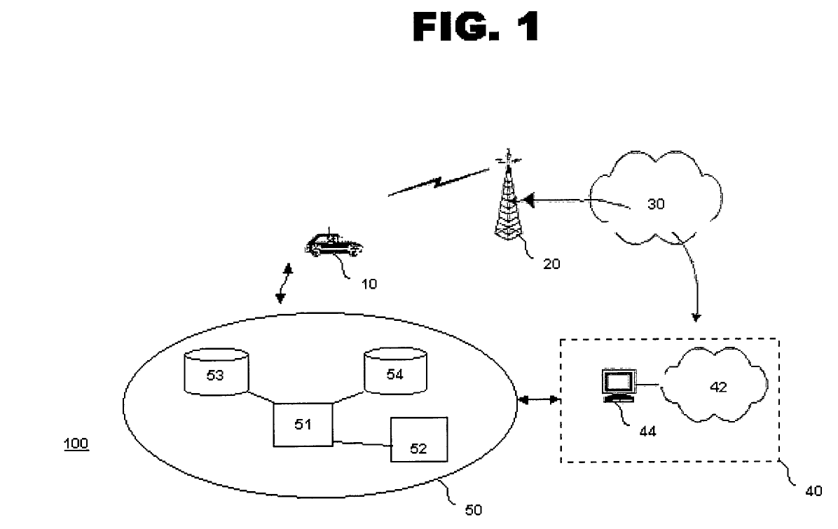

FIG. 1 shows one embodiment of a system for providing services to a vehicle in accordance with the present invention at 100. The system 100 may include one or more vehicle clients 10, one or more carrier systems 20, one or more communication networks 30, one or more service management subsystems 40 and one or more navigation subsystems 50. The service management subsystems may comprise one or more service management applications 42 and one or more service managers 44. The navigation subsystems 50 may comprise one or more route applications 51, 52, and one or more coordinate databases 53, 54.

Navigation subsystem 50 is a system for generating routes to be delivered to vehicle client 10 and for receiving route information from vehicle client 10. Navigation subsystem 50 may be connected with or in communication with service management subsystem 40. Service management subsystem 40 may be used to manage the delivery of information to or from navigation subsystem 50 or to other parts of system 100. Routes may be delivered or information may be received via a live agent, such as a human advisor, or via a virtual agent, such as an interactive computer program.

Navigation subsystem 50 may be any suitable hardware or software configuration, or combination of hardware and software that is configured to generate a route, process route information or receive information from vehicle client 10. In one embodiment of the invention, navigation subsystem 50 comprises one or more route applications 51, 52 and one or more coordinate databases 53, 54. For example, route applications 51, 52 may be any suitable software application for generating route information or otherwise processing route information. Coordinate databases 53, 54 may be any suitable databases for storing route information, such as location coordinates.

Vehicle client 10 may be any suitable vehicle. For example, the vehicle may be an automobile or a passenger-carrying unit such as a bus or train. Alternatively, vehicle client 10 may be an occupant of the vehicle or any suitable client device contained in the vehicle. In one embodiment of the invention, vehicle client 10 is a mobile or portable device equipped to communicate with service management subsystem 40.

Carrier system 20 is any suitable system for transmitting a signal from vehicle 10 to service management subsystem 40. Carrier system 20 may also transmit a signal from service management subsystem 40 to vehicle client 10. In one embodiment of the invention, carrier system 20 is a wireless carrier system as is well known in the art. Carrier system 20 may be, for example, a transmitter/receiver unit attached to vehicle client 10. Alternatively, carrier system 20 may be a separate transmitter/receiver carried by vehicle client 10.

Communication network 30 is any suitable system for communicating between vehicle client 10 and service management subsystem 40. In one embodiment of the invention, communication network is a public switched telephone network (PSTN). Alternatively, communication network 30 may be a multiprotocol Internet or intranet capable of transmitting voice and/or data in either analog or digital form or a combination of both. Alternatively, communication network 30 may be a hybrid communication network or virtual network.

Service management subsystem 40 is a system for managing a variety of services to be delivered to or from vehicle client 10. In one embodiment of the invention, service management subsystem 40 manages services that are distributable over a variety of channels. For example, services may be delivered via a live agent, such as a human advisor, or via a virtual agent, such as an interactive computer program. The structure of service management subsystem 40 may enable services to be delivered in a uniform manner regardless of the channel used for delivery or of the service being delivered. Service management subsystem 40 may maintain a consistent subscriber experience and “look and feel” across the products being delivered across the service distribution channels enabled.

Service management subsystem 40 may be any suitable hardware or software configuration, or combination of hardware and software that is configured to standardize each service being delivered via the subsystem 40 and to standardize each channel of delivery. In one embodiment of the invention, service management subsystem 40 standardizes each service and channel using personalization information from vehicle client 10. Thus, service management subsystem 40 may have a common profile mechanism across the services being delivered independent of the service distribution channel (live agent, virtual agent, web channel, speech channel) and of the service (news, weather, sports, stocks, navigation instructions, etc.). In one embodiment of the invention, service management subsystem includes one or more application components 42 and one or more service managers 44. For example, application 42 may be any suitable software application for managing one or more services. Service managers 44 may be any suitable hardware and/or software configuration or structure for executing applications 42.

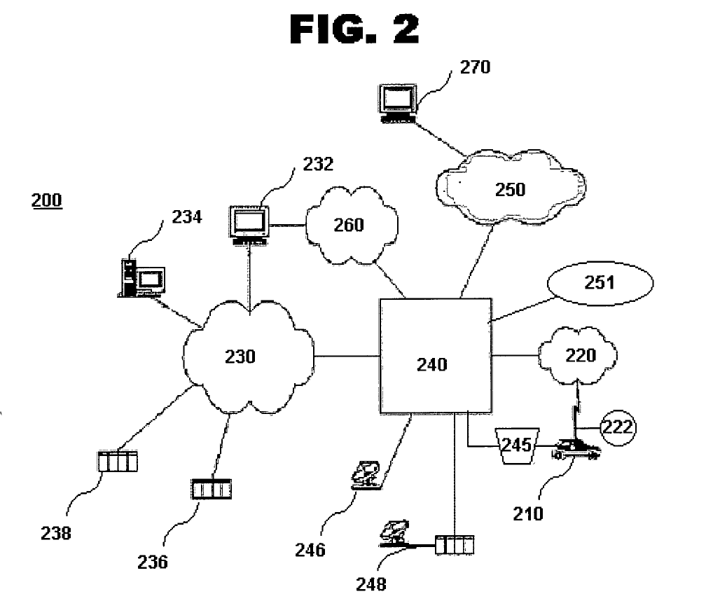

FIG. 2 shows another embodiment of a system for providing services to a vehicle in accordance with the present invention at 200. Vehicle-directed service system 200 may include a subscriber 210 and a service management application 240. In the embodiment shown in FIG. 2, the service management subsystem may be in connection with a communication network 230, such as the Internet. Service management application 240 may also be in communication with service applications or other service management subsystems. For example, in FIG. 2, service management subsystem 240 is also in communication with a subsystem for processing route information shown at 251. Service management subsystem 240 may also be in communication with a web-based service application or other web-based service management systems or web servers. For example, in FIG. 2, service management application 240 is in communication with a web channel 260.

In one embodiment of the invention, service management application may include an in-vehicle component 245. This in-vehicle component may be located in, or on or may be in communication with vehicle client 210. In one embodiment of the invention, the in-vehicle component 245 may install a software algorithm, based on the type of call originated through a voice command, in order to optimize the talk path to subscriber management application 240. System 200 may also allow the subscriber to connect to a live administrator or advisor 270 through a spoken command acknowledged through the subscriber management application 240 voice user interface (VUI).

In one embodiment of the invention, subscriber 210 may have VUI access 222 through a PSTN 220. This may serve as the primary end user interface to service management application 240. This VUI access may allow subscribers in their vehicles equipped in accordance with the present invention to access a variety of services. For example, subscribers 210 may request route information or travel information or may provide information about their route, using voice commands in a conversational manner. Furthermore, the subscriber may have the ability to interrupt or suspend the session if required. In one embodiment of the invention, connections are made to the service management application 240 through the public telephone system. In one embodiment of the invention, subscriber 210 may gain audio access to subscriber management application 240 by activating an in-vehicle speech recognition application. This speech recognition application may allow the subscriber to place hands-free cell phone calls.

Subscriber 210 may also have graphical user interface (GUI) access 232 through a communication network 230, such as the Internet. Such an interface may allow subscribers to access a variety of Internet and communication network-based services in accordance with the present invention. For example, subscriber 210 may access email via this interface. In one embodiment of the invention, subscribers connect to the service management application 240 through the Internet 230 using standard Web browsers.

Subscriber 210 may also have GUI access through a web channel 260. This interface may be used by subscribers to access a variety of services. For example, subscriber 210 may maintain one or more user profiles using web channel 260. Subscriber 210 may also set up user-related rules such as e-mail consolidation and filtering rules. This interface may also be used to access selected content services. Vehicle data, such as diagnostic codes and messages, can be consolidated and displayed using web channel 260. As with other components of system 200, information entered or accessed via web channel 260 may then be incorporated into new products and services for presentation over other channels in communication with service management subsystem 240. The subscribers 210 may connect to the web channel 260 using standard Web browsers. In one embodiment of the invention, standard web channel software interacts with the service management application to update subscriber profiles and/or to obtain information of interest. In one embodiment of the invention, the web channel 260 interface uses a dedicated connection to the service management system 240.

System 200 may also include one or more administrators 270. Administrator 270 may use GUI access to manage service management system 240 and information related to system 200. Administrator 270 may be, for example, a live advisor available to advise subscriber 210. Administrator 270 may also be, for example, an individual maintaining or administering service management subsystem 240. In one embodiment of the invention, administrator 270 accesses service management subsystem 240 via subscriber management subsystem 250. For example, administrator 270 may send configuration and subscriber information to service management system 240. Administrator 270 may also receive notifications of interesting events within system 200. In one embodiment of the invention, subscriber management subsystem 250 uses a dedicated connection between administrator 270 and service management system 240.

As seen in FIG. 2, system 200 may also include one or more message servers 234. These messages may be, for example, voice or text or e-mail mail messages. In one embodiment of the invention, message servers 234 communicate with service management application 240 via Internet 230. Thus, subscribers 210 may receive incoming email messages from, and send outgoing e-mail messages to, external mail transport agents using any suitable messaging protocol as is well known in the art. Message servers 234 may also be used to retrieve subscribers' e-mail from outside mail storage servers for consolidation into their e-mail accounts connected to system 200.

As seen in FIG. 2, system 200 may also include one or more news and or sports feeds 236. In one embodiment of the invention, feeds 236 are provided by a network news content provider. Feeds 236 may be used to receive and store audio news and sports stories for playback to interested subscribers 210. The primary interface between the speech channel and news content provider 236 may be via the Internet 230. In one embodiment of the invention, a satellite feed 246 serves as a backup mechanism.

As seen in FIG. 2, system 200 may also include one or more weather services 248. In one embodiment of the invention, the services are provided by any suitable weather reporting service. Weather services 248 may be used to receive and store regional and local weather information for playback to interested subscribers 210. Furthermore, the weather content can be delivered based on the vehicle location by coordinating the weather zone with the vehicle GPS location. The weather service 248 and/or content feed may be co-located with the service management system 240.

System 200 may also include one or more finance services 238. For example, stock quotes may be provided to the subscriber. Any suitable finance technology may be used to provide these services to interested subscribers. In the embodiment of FIG. 2, the finance information is obtained at the time of the request through Internet attached content sources or dedicated connections 230 as is known in the art.

System 200 may also include other services to be delivered in addition to news, weather, sports and finance services as described above. For example, yellow pages listings, special interest content (e.g., movie or restaurant reviews), content related to the location of the vehicle (e.g. travel profiles of nearby tourist attractions) or content related to navigation of the vehicle may all be delivered via system 200.

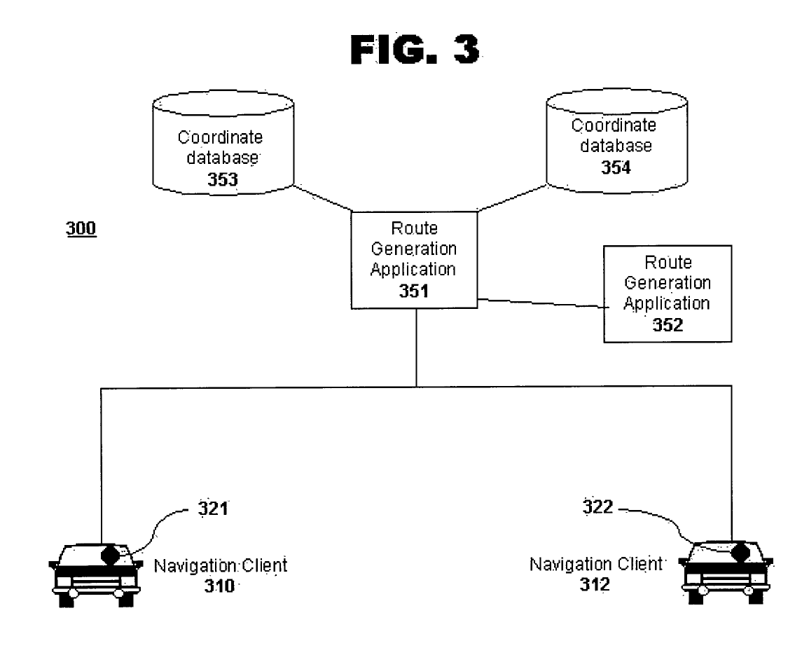

FIG. 3 shows one embodiment of a navigation system in accordance with the present invention at 300. Navigation system 300 may include one or more navigation clients 310, 312. Each navigation client 310, 312 may have an in-vehicle navigator 321, 322. Navigation system 300 may also include one or more route generation applications 351, 352. Navigation system 300 may also include one or more coordinate databases 353, 354.

Navigation clients 310, 312 may be one or more vehicle clients as described above.

In-vehicle navigator 321, 322 may be any suitable component of navigation client 310, 312 which may be used to navigate vehicle client 310. 312. For example, in-vehicle navigator 321, 322 may be a driver. Alternatively, in-vehicle navigator 321, 322 may be an automatic system for navigating vehicle 310, 312.

Route generation applications 351, 352 may be any suitable application for calculating maneuver lists of directions between one or more locations. For example, route generation applications 351, 352 may be any suitable software or hardware programs for managing or calculating routes, portions of route or route coordinates. Route generation applications may include or be able to calculate routes from navigation client's current location to private residences, businesses or recreational facilities. In one embodiment of the invention, route generation applications 351, 352 are in communication with coordinate databases 353, 354.

Route generation applications 351, 352 may generate navigation information in any suitable manner. For example, route generation applications 351, 352 may generate routes using geocoding. That is, the application 351, 352 determines a corresponding latitude and longitude based on an input navigation address. Alternatively, route generation applications 351, 352 may generate routes using reverse geocoding. That is, the application 351, 352 determines a corresponding navigation address based on input latitude and longitude coordinates.

Coordinate databases 353, 354 may be any suitable databases for storing such location coordinates as latitude and longitude of a variety of locations. These locations may be, for example, points of interest. Coordinate databases 353, 354 may also be a database of street addresses. Coordinate databases 353, 354 may also be a database of routes between points.

The service management subsystem 40, service managers 44, applications 42, service management applications 240, subscriber management subsystem 250, and system administrator 270 may all be considered part of the OnStar call center, and will be referred to here as the call center.

Vehicle data may be collected and stored in the memory of a vehicle control processor 245. Types of data to be collected may be defined in an action event table 700 stored in allocated vehicle control processor 245 memory. An upload event table 800 may also be stored in allocated vehicle control processor 245 memory comprising of triggers to upload each data type to the call center. Each data type in the action event table may have a different upload trigger in the upload event table. The action event table and upload event table may be reconfigured remotely at any time by the call center to reflect changes in subscriber services.

When a trigger for data upload occurs, the client vehicle 10, 210 may place a call to the call center to initiate a data upload request. The call center may then verify that the client vehicle 10, 210 is an active service subscriber, and request the uploading of any data that may be pending. After data is uploaded and confirmed received by the call center, the vehicle control processor 245 may clear the memory that was used to store the data, which may then be free to store new data.

The call center may also initiate a request for data upload. The subscriber may request a change in provided services at any time. A change in service may require data collection and upload parameters to be altered on the vehicle control processor. In such a case, the call center may initiate a call to the vehicle and request saved data to be uploaded, clearing the memory. The new parameters may then be downloaded to the vehicle and the updated services may begin.

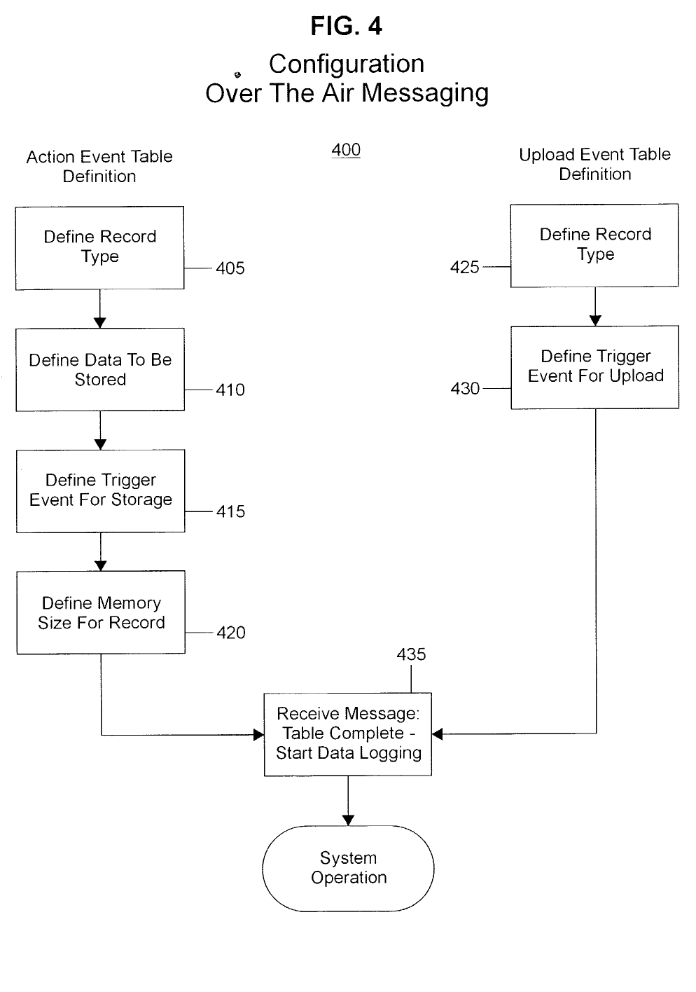

FIG. 4 shows one embodiment of a method for the remote configuration of the action event table 700 and upload event table 800 in accordance with the present invention at 400. Each type of data to be collected may be assigned a unique record type 405, 425 which may be used to tag the data for identification and/or for data organization when being stored. The record type may also be used for data retrieval when specific types of data are requested by the call center to be uploaded. Each entry in the upload event table 800 corresponds to at least one entry in the action event table 700 with a matching record type. The action event table 700 may specify the types of data 410 to be collected and events that may trigger the storage of that data 415. The proper amount of vehicle control processor memory may be allocated to store the collected data 420. Events may be defined to trigger the uploading of the stored data in the upload event table 430. Upon completing the configuration of the tables, the client vehicle 10, 210 may receive from the call center a message that the configuration has been completed 435, and may start logging data.

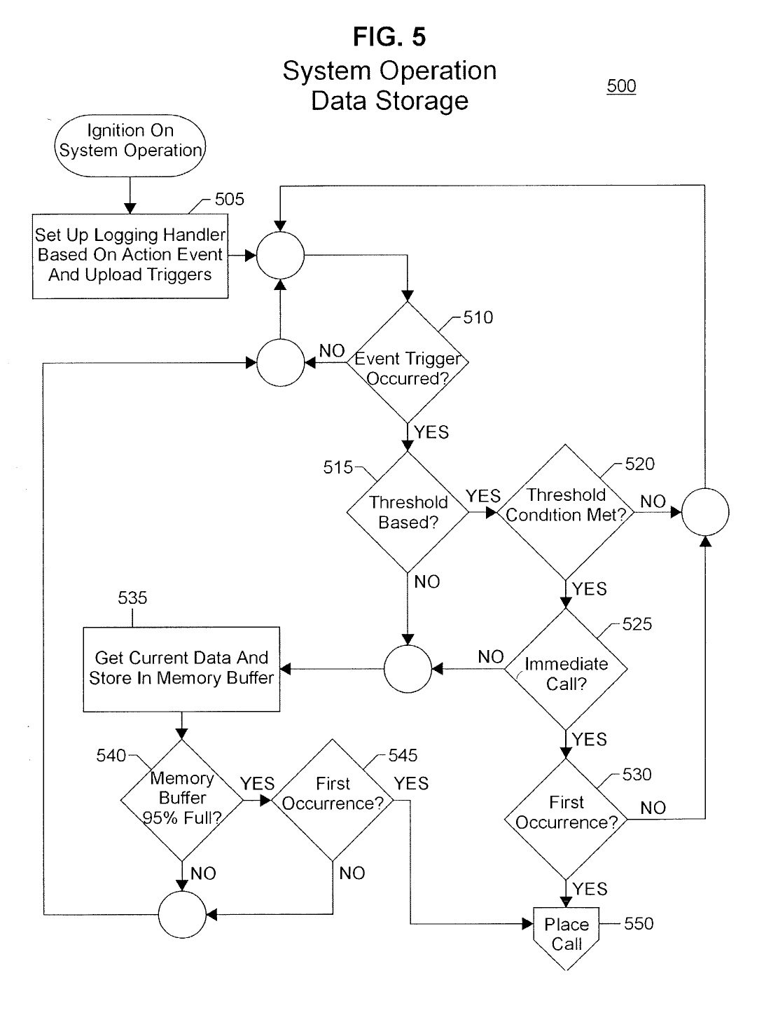

FIG. 5 shows one embodiment for the storing of data at the vehicle control processor 245 in accordance with the present invention at 500. The information stored in the action event table 700 may be used to determine which types of data are to be collected 505. Data may be stored only after a trigger event 730 occurs 510. If the trigger type is based on a threshold 515, data may be stored only after the threshold condition has been met 520. Some threshold based triggers may entail an immediate call to the call center 525. In such a case, only the first occurrence 530 may initiate a call 550 to avoid multiple calls for the same trigger event. If the trigger is not threshold based 515 or does not require an immediate call to the call center 525, the data may be stored in memory 535. To avoid running out of storage memory, a request may be initiated by the client vehicle 10, 210 to upload the stored data and clear the memory when an arbitrary amount of memory has been filled with data 540. For example, in FIG. 5 a memory limit of 95 percent has been chosen 540. Only the first occurrence of full memory may initiate a call 545 to avoid multiple data upload call requests. After a successful data upload and clearing of vehicle control processor memory, the first occurrence condition may be reset for later data upload requests.

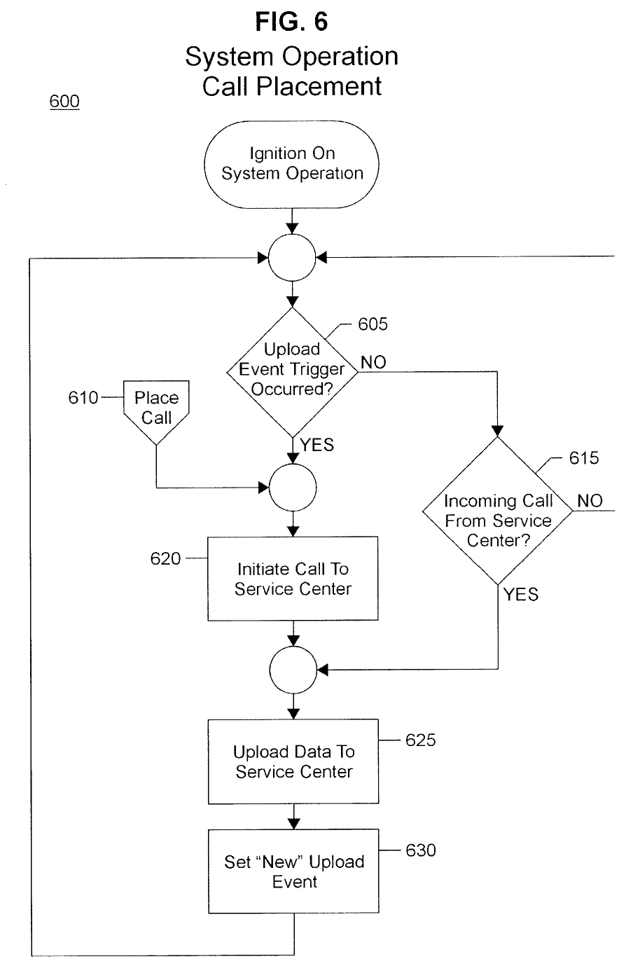

FIG. 6 shows one embodiment for the placement of a call to the call center for a data upload request in accordance with the present invention. The client vehicle 10, 210 may place a call to the call center 610, 620. Vehicle data may be uploaded to the call center 625 and the memory of the vehicle control processor may be cleared and used to store new data. A new upload trigger event may then be set 630 to specify the next time or condition under which data should be uploaded. The vehicle control processor may then wait for the next upload event to occur 605. The call center may make a request for data upload or attempt to reconfigure the action event table or upload event table 615 at any time. Such a request is initiated by the call center and does not require a call from the client vehicle.

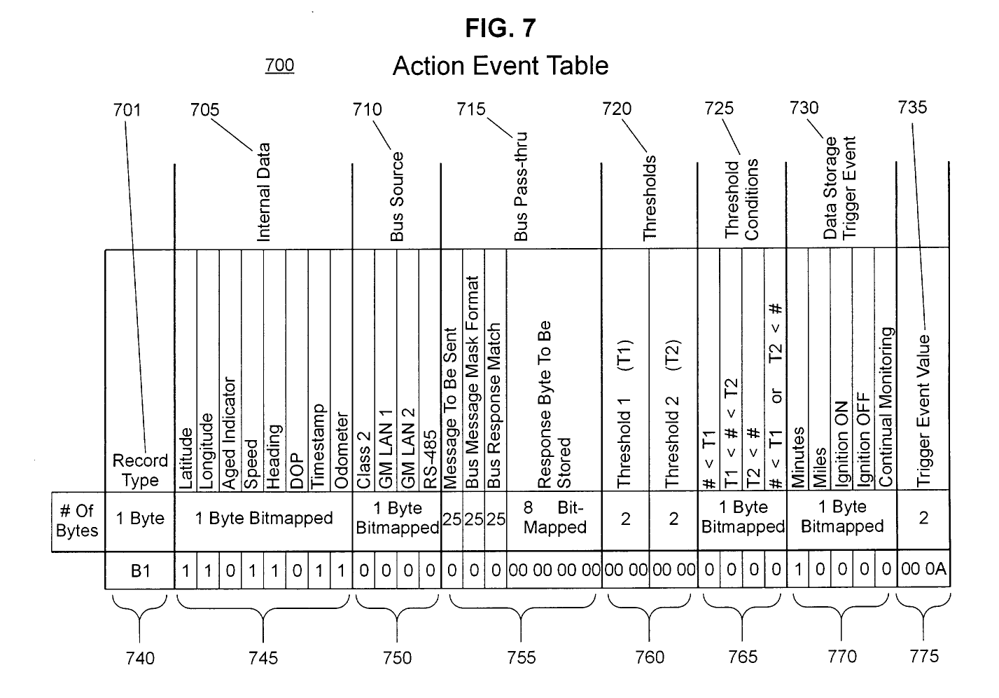

FIG. 7 shows one embodiment for the configuration of the action event table 700 in accordance with the present invention. Each entry in the action event table 700 may contain a record type 701, internal data selector 705, a bus source 710, bus pass-thru data 715, thresholds 720, threshold conditions 725, a data storage trigger event 730, and a trigger event value 735. The record type 701 may be arbitrarily assigned. Internal data selector 705 may be the type of data collected, which may include latitude and longitude information from the GPS, aged indicator, vehicle speed, vehicle heading, DOP, timestamp, and odometer readings. DOP (Dilution Of Precision) pertains to global positioning system error in tracking an object by satellite. The bus source 710 may be used to select the bus type to send or receive a specific message. For example, a “Service Vehicle Soon” action event may require an immediate call to the call center. The bus pass-thru 715 may contain a request by the vehicle control processor for information that is not normally broadcast over the bus, such as engine conditions outside of the normal operating parameters. Thresholds 720 may be implemented so that data may not be stored until a threshold condition 725 is met. The data storage trigger event 730 may determine the conditions under which data may be stored. For example, the data storage trigger event 730 may result in data storage after a given time has elapsed, a given number of miles have been traveled, every time the ignition is turned on or off, or monitored continually. Every time this condition occurs, it triggers data to be stored. The trigger event value 735 contains the actual value that triggers data storage specified in the data storage trigger event 730. For example, this may consist of the number of minutes elapsed or number of miles traveled after which to store data.

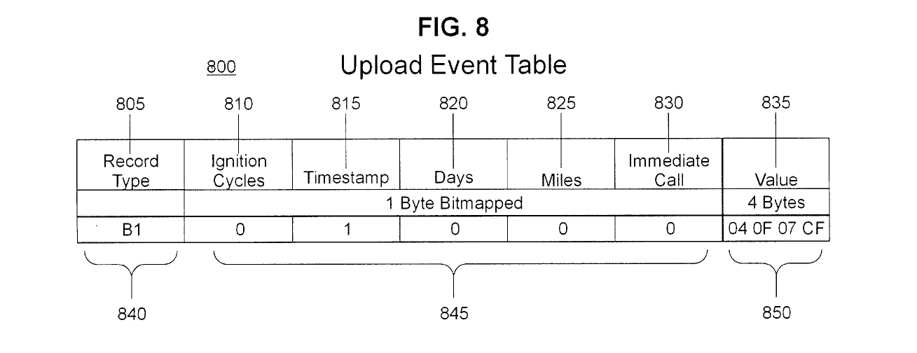

FIG. 8 shows one embodiment for the configuration of the upload event table 800 in accordance with the present invention. The upload event table 800 entries may contain data that specifies an event that triggers a data upload request. Each entry may contain a record type 805, an upload event 810, 815, 820, 825, 830, and a value 835 for the upload event. The upload event may consist of ignition cycles 810, timestamp 815, days elapsed 820, miles elapsed 825, or immediate call 830. Record type 805 specifies which type of data may be uploaded upon the given trigger, and corresponds to the record type of at least one entry in the action event table 700. The ignition cycles trigger 810 may specify that data may be uploaded after a given number of ignition cycles have occurred. The timestamp trigger 815 may specify that data may be uploaded after a given date, specified in value 835, has passed. The days trigger 820 may specify that data may be uploaded after a given number of days, specified in the value 835, has elapsed. The miles trigger 825 may specify that data may be uploaded after a given number of miles, specified in value 835, have been traveled by the vehicle.

FIG. 7 and FIG. 8 illustrate one example of configuring the action event table and the upload event table to provide service for an insurance profile. The client in this example has informed the call center of a request to track latitude, longitude heading, speed, timestamp and odometer information. Data is to be collected every ten minutes, and will be uploaded to the call center on Apr. 15, 1999. This request may have been made through a voice call to the call center or may have been entered into a web site.

The entry in the action event table for this service request may be encoded as follows:

A byte identifying a record type 701 of “B1” in hexadecimal format 740 may be assigned for data tagging purposes. The internal data 705 byte may contain a “1” for each type of data to be collected and a “0” for data types not collected. Therefore latitude, longitude, speed, heading, timestamp and odometer are each assigned “1” and aged indicator and DOP are assigned “0” 745. This byte may be translated to a hexadecimal representation. Since no messages will be sent over the bus, the bus source byte 710 and bus pass-thru 715 have all been assigned zeros 750, 755. The requested data is not threshold based, and the threshold 720 and threshold condition 725 bytes contain zeros 760, 765. The data storage trigger event 730 is set for minutes 770, and the trigger event value 735 is set to “0A” 775 in hexadecimal format, translating to “10” in decimal format. This instructs the vehicle control processor to collect latitude, longitude, speed, heading, timestamp and odometer information every ten minutes.

A corresponding entry in the upload event table 800 may be configured to instruct the vehicle control processor when to upload the data. Record type 805 is assigned “B1” 840, matching the record type in the action event table 700 entry. The client has requested the data to be uploaded on Apr. 15, 1999, so the timestamp 815 is assigned “1” and ignition cycles 810, days 820, miles 825 and immediate call 835 are all assigned “0” 845, signifying that only the timestamp trigger may initiate a data upload request by the vehicle for this particular data set. The value 835 is assigned a hexadecimal value of “04 0F 07 CF” 850, which translates to “Apr. 15, 1999” in decimal format to reflect a date of Apr. 15, 1999 or Apr. 15, 1999.

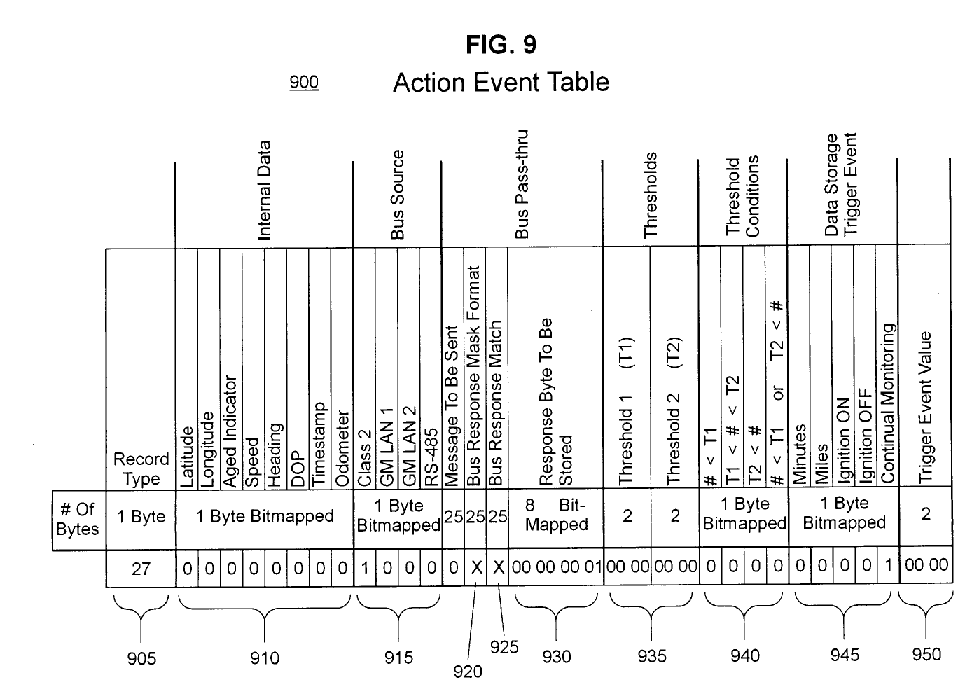

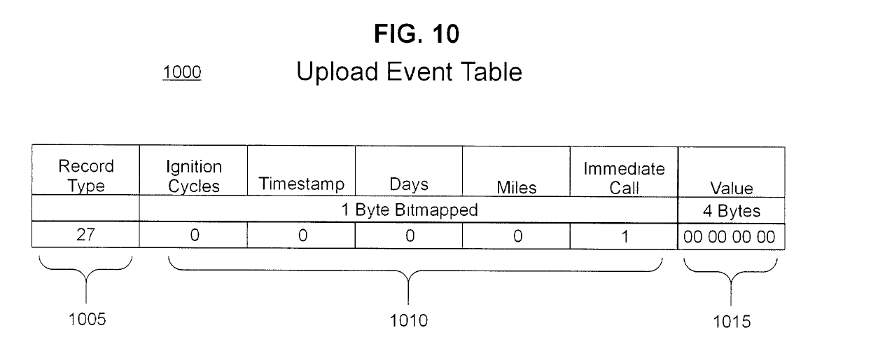

FIG. 9 and FIG. 10 illustrate an example of configuring the action event table 700 and the upload event table 800 to provide a service to monitor when the engine should be serviced. In this case, no data is to be collected. The vehicle's communication bus is to be monitored continuously for a “Service Engine Soon” message. When this message occurs on the vehicle's bus, an immediate call may be placed to the call center. The request for this service may have been made through a voice call to the call center or may have been entered into a web site.

The entry in the action event table for this service request may be encoded as follows:

A byte identifying a record type of “27” in hexadecimal format 905 may be assigned for data tagging purposes. The internal data byte 910 contains a “0” for all predefined data types. Bus source “Class 2” is selected 915 to monitor the class 2 bus for the “Service Engine Soon” message. Bus response mask 920 is set to mask off portions of the bus message that do not pertain to the “Service Engine Soon” message. Bus response match is set to a value corresponding to the “Service Engine Soon” message 925 and a logical AND operation is performed on each message sent over the bus with the bus response mask 920, and the result is compared to the bus response match 925, which in this case is the “Service Engine Soon” message. When a match occurs the response byte to be stored 930 specifies which byte from the original bus message contains the pertinent data, which in this case is the least significant byte and is indicated by “00 00 00 01”. No thresholds are being utilized here, and so all threshold data is set to zero 935, 940. The data storage trigger event is set to continually monitor 945. No trigger event value is set 950 because in this case an immediate call will be placed to the call center as soon as the “Service Engine Soon” message occurs on the vehicle's communication bus.

FIG. 10 shows the upload event table entry for this service. The record type of “27” 1005 matches the record type in the action event table 905. The upload trigger is set for an immediate call 1010, and so no value is set for the trigger 1015.

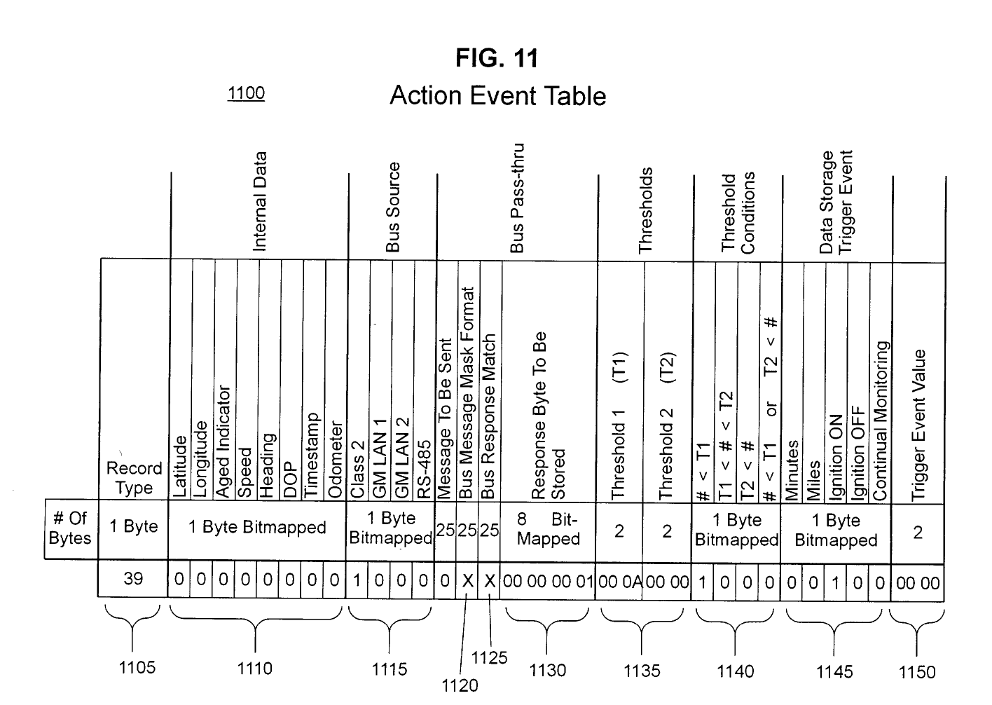

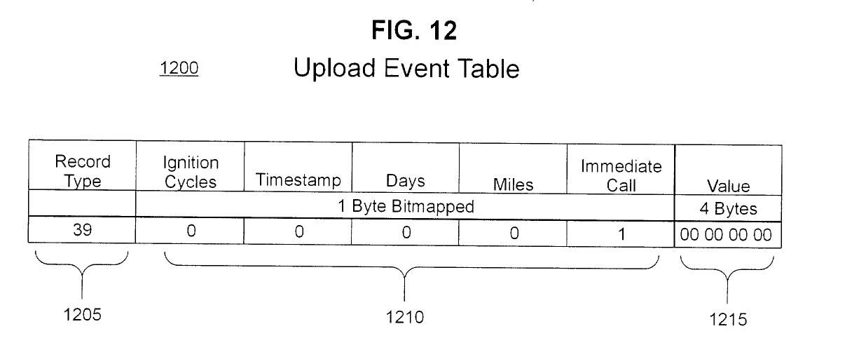

FIG. 11 and FIG. 12 illustrate an example of configuring the action event table and the upload event table to provide a service to monitor oil life. The client in this example has requested the call center to notify when the vehicle's oil life status falls below 10 percent of life remaining. The vehicle's communication bus is to be monitored at each ignition on cycle and place an immediate call to the call center if the result is ever below 10 percent. This request may have been made through a voice call to the call center or may have been entered into a web site.

The entry in the action event table for this service request may be encoded as follows:

A byte identifying a record type of “39” in hexadecimal format 1105 may be assigned for data tagging purposes. The internal data 1110 byte contains a “0” for all predefined data types. Bus source “Class 2” is selected 1115 to monitor the class 2 bus, which carries messages including those pertaining to the engine and oil system. Bus response mask is set 1120 to mask off portions of the bus message that are not pertinent to the oil life. Bus response match is set to a value corresponding to oil life messages 1125 and a logical AND operation is performed on each message sent over the bus with the bus response mask 1120, and the result is compared to the bus response match 1125. When a match occurs the response byte to be stored 1130 specifies which byte in the original bus message contains the pertinent data, which in this case is the least significant byte and is indicated by “00 00 00 01”. The threshold for the data in this case is 10 percent, and so the value of threshold 1 (T1) is set to 10, represented in hexadecimal format by “0A” 1135. The threshold condition is set to trigger when the reading is less than the value of T1 1140. The data storage trigger event is set to monitor at each ignition on cycle 1145. No trigger event value is set 1150 because in this case an immediate call will be placed to the call center as soon as the oil life status drops below the threshold.

FIG. 12 shows the upload event table entry for this service. The record type of “39” 1205 matches the record type in the action event table 1105. The upload trigger is set for an immediate call 1210, and so no value is set for the trigger 1215.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim

1. A method of uploading data from a vehicle comprising:
selecting at least one type of data to upload;
storing the data type on a vehicle control processor;
selecting at least one data upload trigger event;
storing the data upload trigger event on the vehicle control processor; and
uploading the data corresponding to the stored data type based on an occurrence of the upload trigger event.

2. The method of claim 1 further comprising storing data of the at least one data type in the vehicle control processor memory.

3. The method of claim 2 further comprising allocating memory in the vehicle control processor to receive the data.

4. The method of claim 1 further comprising selecting a store data trigger event, and storing the data corresponding to the selected type of data based on the store data trigger event.

5. The method of claim 1 wherein the at least one selection of data type and the at least one data upload trigger event is programmed from a remote node in communication with the vehicle control processor.

6. The method of claim 1 wherein the selection of data type and trigger event is based on user preferences.

7. The method of claim 1 wherein the data type is selected from a group consisting of latitude, longitude, aged indicator, speed, heading, DOP, timestamp, and odometer readings.

8. The method of claim 1 wherein the data upload trigger event is selected from a group consisting of number of ignition cycles, timestamp, number of days elapsed, miles traveled, and immediate call.

9. The method of claim 1 wherein the upload occurs while the vehicle ignition is powered off.

10. The method of claim 1 further comprising downloading information to the vehicle responsive to the uploaded data.

11. The method of claim 1 wherein the type of data to be collected is stored in an action event table.

12. The method of claim 1 wherein the data upload trigger event is stored in an upload event table.

13. A system for a method of uploading data from a vehicle comprising:
means for selecting at least one type of data to upload;
means for storing the data type on a vehicle control processor;
means for selecting at least one data upload trigger event;
means for storing the data upload trigger event on the vehicle control processor; and
means for uploading the data corresponding to the stored data type based on an occurrence of the upload trigger event.

14. The system of claim 13 further comprising:
means for selecting a store data trigger event, and storing the data corresponding to the selected type of data based on the store data trigger event.

15. A computer usable medium for uploading data from a vehicle comprising:
computer readable program code to select at least one type of data to upload;
computer readable program code to store the data type on a vehicle control processor;
computer readable program code to select at least one data upload trigger event;
computer readable program code to store the data upload trigger event on the vehicle control processor; and
computer readable program code to upload the data corresponding to the stored data type based on an occurrence of the upload trigger event.

16. The computer usable medium of claim 15 further comprising:
computer readable program code for selecting a store data trigger event, and storing the data corresponding to the selected type of data based on the store data trigger event.

17. The computer usable medium of claim 15 wherein the at least one selection of data type and the at least one data upload trigger event is programmed from a remote node in communication with the vehicle control processor.

18. The computer usable medium of claim 15 wherein the selection of data type and trigger event is based on user preferences.

19. The computer usable medium of claim 15 wherein the data type is selected from a group consisting of latitude, longitude, aged indicator, speed, heading, DOP, timestamp, and odometer readings.

20. The computer usable medium of claim 15 wherein the data upload trigger event is selected from a group consisting of number of ignition cycles, timestamp, number of days elapsed, miles traveled, and immediate call.
